(19) United States
(12) Patent Application Publication
(10) Pub. No.: US 2021/0278343 A1
(43) Pub. Date: Sep. 9, 2021

(54) TRACKING APPLICATION COVERAGE AND DEGRADATION OF ANTIMICROBIAL CHEMICAL COMPOSITIONS

(71) Applicant: Mshield Holdings Inc., Beachwood, OH (US)

(72) Inventors: Steven Rosen, Hunting Valley, OH (US); Dave Johnson, Westlake, OH (US); Steve Kubec, Cleveland, OH (US)

(21) Appl. No.: 17/193,226

(22) Filed: Mar. 5, 2021

Related U.S. Application Data
(60) Provisional application No. 62/985,941, filed on Mar. 6, 2020.
(60) Provisional application No. 63/122,063, filed on Dec. 7, 2020.

(51) Int. Cl. G01N 21/64; G01N 21/01; G01N 21/33; A01N 43/32; H04N 5/232; G01N 21/17; A01N 55/00; A01N 43/26; H04N 5/225

(52) U.S. Cl. CPC G01N 21/643; G01N 21/01; G01N 21/33; A01N 43/32; H04N 5/23206; G01N 2021/0131; A01N 55/00; A01N 43/26; H04N 5/2256; G01N 2021/1746; G01N 2021/6439; G01N 21/1717

(57) ABSTRACT

Techniques regarding tracking the application coverage of an antimicrobial coating and/or monitoring the degradation of the antimicrobial coating on a surface are provided. For example, one or more embodiments described herein can comprise a method that includes forming an antimicrobial coating by mixing a first solution comprising a tracer compound with a second solution comprising an antimicrobial compound. The method can further include inhibiting growth of a microbe on a surface by applying the antimicrobial coating to the surface.

### CROSS-REFERENCE TO RELATED APPLICATIONS

This application is a non-provisional of U.S. Provisional Application No. 62/985,941, entitled, “TRACKING APPLICATION COVERATE AND DEGRADATION OF ANTIMICROBIAL CHEMICAL COMPOSITIONS,” filed on Mar. 6, 2020, and U.S. Provisional Application No. 62/122,063, entitled, “TRACKING APPLICATION OF AN ANTIMICROBIAL COMPOSITION,” filed on Dec. 7, 2020. The entirety of the aforementioned applications is hereby incorporated herein by reference.

### BACKGROUND

The subject disclosure relates to tracking application coverage and/or degradation of one or more antimicrobial coatings, and more specifically, to incorporating a tracer into the application of one or more antimicrobial chemical compositions onto one or more surfaces to track application coverage and/or monitor degradation of the antimicrobial coatings on the surfaces.

Antimicrobial compounds can be applied to a variety of surfaces to eliminate existing microbes and/or inhibit the presence and/or growth of future microbes on the surfaces. For instance, commonly touched surfaces (e.g., doorknobs, furniture, and/or countertops) can be coated with an antimicrobial compound to inhibit the spread of one or more pathogens. However, the antimicrobial activity associated with these compounds is only as effective as the coverage of the antimicrobial compounds on the target surfaces. For instance, areas of the target surfaces left uncoated can be subjected to the presence of undesirable microbes.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, apparatuses and/or computer program products regarding the application and/or monitoring antimicrobial chemical compositions are described.

According to an embodiment, a method is provided. The method can comprise forming an antimicrobial coating by mixing a first solution comprising a tracer compound with a second solution comprising an antimicrobial compound. The method can also comprise inhibiting growth of a microbe on a surface by applying the antimicrobial coating to the surface. In some examples, the method can further comprise tracking application coverage of the antimicrobial coating on the surface by illuminating the surface with ultraviolet light and detecting light emitted by the tracer compound. In one or more examples, the method can further comprise monitoring degradation of the antimicrobial coating on the surface by periodically determining whether the surface emits light in response to being radiated with ultraviolet light.

According to another embodiment, a system is provided. The system can comprise a memory that can store computer executable components. The system can also comprise a processor, operably coupled to the memory, and that executes the computer executable components stored in the memory. The computer executable components can comprise a tracking component that can determine whether an antimicrobial coating is present on a surface by analyzing at least one of image data and sensor data regarding visible light emitted by the surface. The antimicrobial coating can include a fluorescent tracer compound that emits the visible light in response to being radiated with ultraviolet light. In some examples, the system can also comprise an analysis component that can identify a first region of the surface coated with the antimicrobial coating based on a location of fluorescence emitted by the tracer compound and represented in the image data. Further, one or more examples can include a notification component that can generate a notification based on an area of the first region of the surface being less than a defined percentage of a total area of the surface. Moreover, the system can comprise a scheduling component that can schedule an additional application of the antimicrobial coating to the surface based on the notification.

According to another embodiment, a computer-implemented method is provided. The computer-implemented method can comprise tracking, by a system operatively coupled to a processor, a presence of an antimicrobial coating on a surface based on an identification of fluorescence in image data representing an image of the surface. In some examples, the computer-implemented method can also comprise illuminating, by the system, the surface with ultraviolet light, and generating, by the system, the image data via a camera monitoring the surface during the illuminating. In one or more examples, the computer-implemented method can further comprise analyzing, by the system, the image data to identify light having a defined wavelength corresponding to the fluorescence. Moreover, the computer-implemented method can comprise determining, by the system, a location of the antimicrobial coating on the surface based on the identified light. Advantageously, the various embodiments described herein can track application coverage and/or monitor degradation of an antimicrobial coating on a surface based on the fluorescence of one or more tracer compounds in the coating.

### BRIEF DESCRIPTION OF THE DRAWINGS

FIG. 1 illustrates a flow diagram of an example, non-limiting method regarding the disbursement of an antimicrobial coating on one or more surfaces in accordance with one or more embodiments described herein.

FIG. 2 illustrates a flow diagram of an example, non-limiting method regarding the disbursement and/or monitoring of an antimicrobial coating on one or more surfaces in accordance with one or more embodiments described herein.

FIG. 3 illustrates a block diagram of an example, non-limiting system that can facilitate monitoring application coverage and/or degradation of one or more antimicrobial coatings on one or more surfaces in accordance with one or more embodiments described herein.

FIG. 4 illustrates a block diagram of an example, non-limiting system that can control one or more optical devices (e.g., light sources and/or cameras) to facilitate tracking application coverage and/or degradation of one or more antimicrobial coatings on one or more surfaces in accordance with one or more embodiments described herein.

FIGS. 5A and 5B illustrate diagrams of an example, non-limiting mobile device that can be employed to track the application of one or more antimicrobial coatings in accordance with one or more embodiments described herein.

FIG. 6 illustrates a diagram of an example, non-limiting system that can employ various light sources and/or cameras to tracking application coverage and/or degradation of one or more antimicrobial coatings on one or more surfaces in accordance with one or more embodiments described herein.

FIG. 7 illustrates a block diagram of an example, non-limiting system that can analyze image and/or sensor data to track the application coverage and/or degradation of one or more antimicrobial coatings on one or more surfaces in accordance with one or more embodiments described herein.

FIG. 8 illustrates a block diagram of an example, non-limiting system that can analyze image and/or sensor data to track the application coverage and/or degradation of one or more antimicrobial coatings on one or more surfaces in accordance with one or more embodiments described herein.

FIG. 9 illustrates a block diagram of an example, non-limiting system that can generate one or more notifications and/or schedules regarding the application of one or more antimicrobial coatings in accordance with one or more embodiments described herein.

FIG. 10 illustrates a flow diagram of an example, non-limiting computer-implemented method that can facilitate tracking one or more applications of antimicrobial coatings in accordance with one or more embodiments described herein.

FIG. 11 illustrates a diagram of an example, non-limiting backpack apparatus that can contain a plurality of chemical compositions for disbursement of an antimicrobial coating via a sprayer device (e.g., an electrostatic sprayer) in accordance with one or more embodiments described herein.

FIG. 12 illustrates a diagram of an example, non-limiting side view of a backpack apparatus that can contain a plurality of chemical compositions for disbursement of an antimicrobial coating via a sprayer device (e.g., an electrostatic sprayer) in accordance with one or more embodiments described herein.

FIG. 13 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Given the problems with other implementations of applying antimicrobial compounds to one or more object surfaces; the present disclosure can be implemented to produce a solution to one or more of these problems by tracking application coverage and/or degradation of one or more antimicrobial coatings on one or more surfaces. Advantageously, one or more embodiments described herein can employ one or more tracer compounds to identify the presence, or lack thereof, of an antimicrobial coating on one or more surfaces. For example, fluorescent compounds can be applied to the surfaces along with the one or more antimicrobial coatings, where the fluorescent compounds can be identified using ultraviolet (“UV”) light. Additionally, one or more computer systems can be employed to autonomously monitor the application coverage and/or degradation of the antimicrobial coatings. Further, the one or more antimicrobial coatings and tracer compounds can advantageously be applied simultaneously via one or more electrostatic sprayers.

One or more embodiments of the present invention can be directed to methods of applying one or more antimicrobial compounds to surfaces for the inhibition of one or more pathogens (e.g., to inhibit growth of bacteria, fungi, and/or viruses). For example, one or more embodiments described herein can regard antimicrobial compounds mixed with one or more tracer compounds to facilitate detection. For instance, the tracer compound can be a fluorescent compound that absorbs ultraviolet (“UV”) light and emits visible light. Further, various embodiments be directed to computer processing systems, computer-implemented methods, apparatus and/or computer program products that facilitate the efficient, effective, and autonomous (e.g., without direct human guidance) tracking of the application of the antimicrobial compounds on one or more target surfaces by detecting the tracer compounds. For example, one or more embodiments described herein can control: one or more light sources to illuminate the target surfaces with UV light, and one or more cameras to capture images of fluorescence exhibited by the tracer compounds on the target surfaces. Based on the captured images, one or more embodiments described herein can determine whether or not the tracer compound, and thereby the antimicrobial compound, is present on the target surfaces. Further, one or more embodiments described herein can generate notifications and/or schedules regarding application of the one or more antimicrobial compounds based on the analysis of the captured images.

In some embodiments, the one or more autonomous tracking systems described herein can be embodied in a single device. For instance, various computer components described herein can be included in a smartphone outfitted with UV light generator, where the smartphone can be brought to the target surface of interest to determine whether the tracer compound, and thereby the antimicrobial compound, is present. In some embodiments, the one or more autonomous tracking systems described herein can be embodied in system of multiple devices communicating with each within a defined space (e.g., within a room, floor, building, and/or facility of buildings).

Additionally, various embodiments described herein can regard one or more devices and/or containers for distributing the one or more antimicrobial coatings. For example, one or more electrostatic sprayer devices equipped with a dual compartment storage system can be employed to apply the one or more antimicrobial compounds and tracer compounds to the target surfaces. In one or more embodiments, the dual compartment storage system can be configured to mix the one or more antimicrobial compounds and/or tracer compounds in one or more defined ratios during the application process.

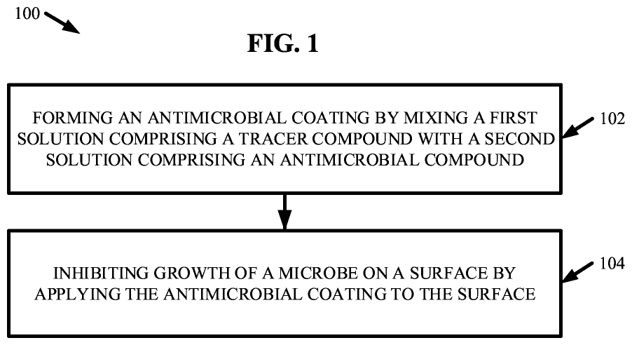

FIG. 1 illustrates a flow diagram of an example, non-limiting method 100 that can facilitate disbursement of one or more antimicrobial compositions onto one or more target surfaces to form an antimicrobial coating in accordance with one or more embodiments described herein. Repetitive description of like elements employed in other embodiments described herein is omitted for sake of brevity. At 102, the method 100 can comprise forming an antimicrobial coating by mixing a first solution comprising one or more tracer compounds with a second solution comprising one or more antimicrobial compounds.

For example, the first solution can be a tracer chemical composition comprising the one or more tracer compounds. In various embodiments described herein, the one or more tracer chemical compositions can absorb UV radiation and emit visible light. For instance, the one or more tracer chemical compositions can comprise one or more tracer compounds that can absorb light in the UV and/or violet region of the electromagnetic spectrum and re-emit visible light by fluorescence. The one more tracer chemical compositions can comprise one or more tracer compounds that contain one or more phosphors. Example tracer compounds can include, but are not limited to: optical brighteners, optical brightening agents, fluorescent brightening agents, fluorescent whitening agents, fluorescent compounds, a combination thereof, and/or the like. Further, the one or more tracer compounds can be organic compounds that are colorless until activated by UV radiation. Additionally, the one or more tracer chemical compositions described herein can be dyed so as to emit a desired color of light when activated by UV radiation.

The second solution can be an antimicrobial chemical composition comprising the one or more antimicrobial compounds. In various embodiments described herein, the one or more antimicrobial chemical compositions can exhibit antimicrobial activity to eliminate (e.g., biocidal activity) one or more microbes and/or inhibit the growth of one or more microbes. For example, the one or more antimicrobial chemical compositions can exhibit broad spectrum antimicrobial activity towards bacteria (e.g., Gram-positive bacteria and/or Gram-negative bacteria), fungi, viruses, mold, and/or mildew. Further, the one or more antimicrobial compositions can exhibit the antimicrobial activity chemically and/or mechanically (e.g., puncturing the cell membrane of the target microbe). For example, the one or more antimicrobial compositions can exhibit antimicrobial activity via one or more lytic mechanisms.

In various embodiments, the one or more antimicrobial compounds can be organosilane compounds that can mechanically rupture the cell membrane of a target microbe. Example antimicrobial compounds can include, but are not limited to: 3-(trihydroxysilyl) propyl dimethyl octadecyl ammonium chloride, 3-(trimethoxysilyl)propyl dimethyl octadecyl ammonium chloride, 1-tetradecanaminiumN,N-dimethyl-N-(3-(trimethoxysilyl)propyl)-chloride, N,N-didecyl-N-methyl-3-(trihydroxysilyl)propyl dimethyl octoadecyl ammonium chloride, a combination thereof, and/or the like. Additionally, the one or more antimicrobial compounds can supplement and/or enhance the antimicrobial activity of one or more other antimicrobial agents comprised within the one or more antimicrobial chemical compositions. For example, the one or more other antimicrobial agents can provide initial biocidal activity against microbes that contact the antimicrobial chemical composition, while the one or more antimicrobial compounds can provide long-lasting antimicrobial activity via one or more mechanical mechanism (e.g., rupturing of one or more cell membranes). Example antimicrobial agents can include, but are not limited to: β-lactams, aminoglycoside, macrolides, quinolones, flouroquinolones, a combination thereof, and/or the like. Additionally, the one or more antimicrobial chemical compositions can comprise one or more binding agents. In one or more embodiments, the one or more antimicrobial chemical compositions can be bactericidal and/or bacteriostatic.

In various embodiments, the one or more antimicrobial coatings can comprise a homogeneous, or substantially homogenous, mixture of the one or more tracer chemical compositions and/or antimicrobial chemical compositions. For example, the one or more tracer compounds and/or antimicrobial compounds can form one or more stereocomplexes as a result of the mixture. In another example, the one or more tracer chemical compositions and/or antimicrobial chemical compositions can chemically react, where the one or more tracer compounds can be covalently bonded to the one or more antimicrobial compounds. For instance, the one or more tracer chemical compositions and/or the one or more antimicrobial chemical compositions can further comprise one or more catalysts to facilitate a chemical reaction that synthesizes the one or more antimicrobial coating. In a further example, the one or more tracer chemical compositions and/or antimicrobial chemical compositions can be electro-chemically attracted to each other (e.g., exhibiting opposite charges). As a result of the chemical and/or physical properties of the one or more tracer chemical compositions and/or antimicrobial chemical compositions, the one or more antimicrobial coatings can: be bactericidal, be bacteriostatic, exhibit chemical antimicrobial activity, exhibit mechanical antimicrobial activity, be fluorescent, and/or emit visible light in the presence of UV radiation.

At 104, the method 100 can comprise inhibiting the growth of one or more microbes on one or more surfaces by applying the one or more antimicrobial coatings to the one or more surfaces. Additionally, applying the one or more antimicrobial coatings can terminate one or more microbes on the one or more surfaces. In various embodiments, the one or more antimicrobial coatings can be applied to the one or more surfaces via one or more electrostatic sprayer devices. Further, the one or more antimicrobial coatings can be electrically attracted to the one or more surface. Example surfaces that can be covered by the one or more antimicrobial coatings can include but are not limited to: textile surfaces, fabric surfaces, clothing surfaces, leather surfaces, polymer surfaces, plastic surfaces, wood surfaces, metal surfaces, rubber surfaces, organic surfaces, inorganic surfaces, glass surfaces, stone surfaces, ceramic surfaces, paper surfaces, cellulose surfaces, a combination thereof, and/or the like.

In various embodiments, inclusion of the tracer chemical composition in the one or more antimicrobial coatings can facilitate tracking the application coverage of the antimicrobial coatings during application onto the one or more surfaces. For example, UV radiation can be emitted onto the one or more surfaces (e.g., via a black light lamp and/or incandescent black light bulb) so as to trigger fluorescence by the one or more tracer compounds and identify the location of the associate antimicrobial coating. Additionally, inclusion of the tracer chemical composition in the one or more antimicrobial coatings can facilitate monitoring degradation of the one or more antimicrobial coatings on the one or more surfaces. For example, as the one or more antimicrobial coatings degrade, less light will be emitted from the antimicrobial coatings (e.g., originating from the one or more tracer compounds) in the presence of UV radiation.

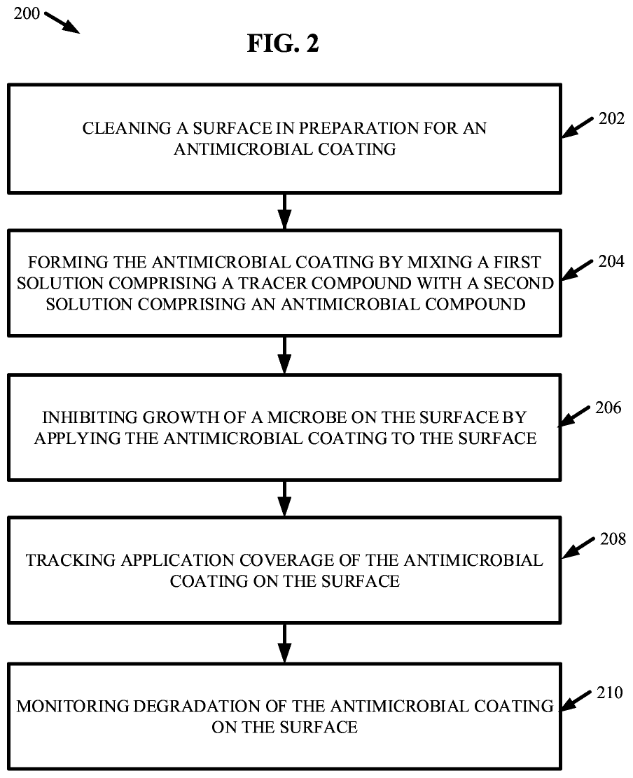

FIG. 2 illustrates another flow diagram of an example, non-limiting method 200 that can also facilitate disbursement of the one or more antimicrobial coatings onto one or more surfaces in accordance with one or more embodiments described herein. Repetitive description of like elements employed in other embodiments described herein is omitted for sake of brevity.

At 202, the method 200 can comprise cleaning one or more surfaces in preparation for the one or more antimicrobial coatings described herein. The cleaning at 202 can include removing one or more contaminants from the one or more surfaces. Example contaminants can include, but are not limited to: dirt, grime, grease, oil, wax, debris, microbes, a combination thereof, and/or the like. In one or more embodiments, the cleaning at 202 can further include sanitizing the one or more surfaces with one or more sanitizer agents. In various embodiments, the cleaning at 202 can facilitate a contact between the one or more antimicrobial coatings and the one or more surfaces and/or an attraction therebetween.

At 204, the method 200 can comprise forming the one or more antimicrobial coatings by mixing one or more first solutions comprising a tracer compound with one or more second solutions comprising an antimicrobial compound. For example, the first solution can be the one or more tracer chemical compositions described herein, and/or the second solution can be the one or more antimicrobial chemical compositions described herein. In various embodiments, the mixing at 204 can be performed at room temperature or at an elevated temperature. Additionally, the mixing at 204 can be performed under pressure, in an ambient environment, and/or in an inert environment.

At 206, the method 200 can comprise inhibiting the growth of one or more microbes on the one or more surfaces by applying the one or more antimicrobial coatings to the one or more surfaces. As described herein, the one or more antimicrobial coatings can exhibit antimicrobial activity via chemical and/or mechanical (e.g., physical rupture of a cell membrane) means. Further, the one or more microbes can include bacteria, fungi, viruses, mold, and/or mildew. In various embodiments, the applying at 206 can be performed via one or more electrostatic sprayer devices. For instance, the one or more electrostatic sprayer devices can disburse the one or more antimicrobial coatings as a charged mist of particles. In one or more embodiments, the mixing at 204 can be performed just prior to the applying at 206. In one or more embodiments, the one or more antimicrobial coatings can be stored for a period of time prior to the applying at 206.

At 208, the method 200 can comprise tracking application coverage of the one or more antimicrobial coatings on the one or more surfaces. For example, the application coverage can regard the position and/or density of the one or more antimicrobial coatings on the one or more surfaces. In various embodiments, the tracking at 208 can include radiating the one or more surfaces with UV radiation in order to detect visible light emitted from the one or more antimicrobial coatings (e.g., via the one or more tracer compounds) as fluorescence. For example, UV radiation can be provided by one or more black light lamps and/or incandescent black light bulbs operated in proximity to the one or more surfaces. For instance, one or electrostatic sprayer devices used to facilitate the applying at 204 can include a UV radiation source. For example, a UV light can be positioned on the electrostatic sprayer device adjacent to (e.g., above and/or below) the nozzle of the electrostatic sprayer device. In one or more embodiments, the one or more antimicrobial coatings can be colorless absent the presence of UV radiation. Thus, one or more UV radiation sources can be utilized in conjunction with the one or more tracer compounds comprised within the one or more antimicrobial coatings to track the application coverage during the applying at 206.

At 210, the method 200 can comprise monitoring the degradation of the one or more antimicrobial coatings on the one or more surfaces. For example, the one or more UV radiation sources can be utilized in conjunction with the one or more tracer compounds comprised within the one or more antimicrobial coatings to further facilitate the monitoring at 210. Where the one or more antimicrobial coatings fully, or near fully, degrade from a portion of the one or more surfaces; the degradation, and/or the surface portion experiencing the degradation, can be identified by a lack of visible light being emitted by the one or more antimicrobial coatings in the presence of UV radiation. Additionally, wherein the one or more antimicrobial coatings are partially degraded from the one or more surfaces; an amount of visible light emitted by the one or more antimicrobial coatings in the presence of UV radiation can diminish in comparison to one or more thresholds associated with visible light emittance exhibited at no degradation. Thereby, the amount of degradation can be determined based on the comparison to the one or more thresholds. In various embodiments, the tracking at 208 and/or the monitoring at 210 can be performed via one or more computer-implemented method and/or autonomous systems described herein.

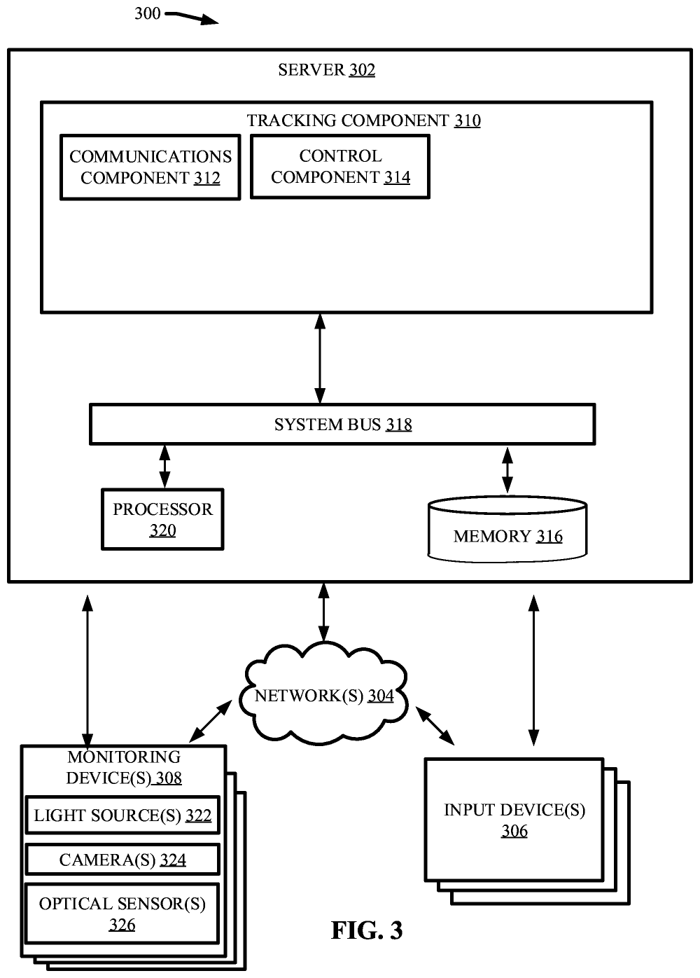

FIG. 3 illustrates a block diagram of an example, non-limiting system 300 that can facilitate tracking application coverage of the one or more antimicrobial coatings and/or monitoring degradation of the one or more antimicrobial coatings in accordance with one or more embodiments described herein. Repetitive description of like elements employed in other embodiments described herein is omitted for sake of brevity. Aspects of systems (e.g., system 300 and the like), apparatuses or processes in various embodiments of the present invention can constitute one or more machine-executable components embodied within one or more machines (e.g., embodied in one or more computer readable mediums (or media) associated with one or more machines). Such components, when executed by the one or more machines (e.g., computers, computing devices, virtual machines, etc.) can cause the machines to perform the operations described.

As shown in FIG. 3, the system 300 can comprise one or more servers 302, one or more networks 304, input devices 306, and/or monitoring devices 308. The server 302 can comprise tracking component 310. The tracking component 310 can further comprise communications component 312 and/or control component 314. Also, the server 302 can comprise or otherwise be associated with at least one memory 316. The server 302 can further comprise a system bus 318 that can couple to various components such as, but not limited to, the tracking component 310 and associated components, memory 316 and/or a processor 320. While a server 302 is illustrated in FIG. 3, in other embodiments, multiple devices of various types can be associated with or comprise the features shown in FIG. 3. Further, the server 302 can communicate with one or more cloud computing environments.

The one or more networks 304 can comprise wired and wireless networks, including, but not limited to, a cellular network, a wide area network (WAN) (e.g., the Internet) or a local area network (LAN). For example, the server 302 can communicate with the one or more input devices 306 and/or monitoring devices 308 (and vice versa) using virtually any desired wired or wireless technology including for example, but not limited to: cellular, WAN, wireless fidelity (Wi-Fi), Wi-Max, WLAN, Bluetooth technology, a combination thereof, and/or the like. Further, although in the embodiment shown the tracking component 310 can be provided on the one or more servers 302, it should be appreciated that the architecture of system 300 is not so limited. For example, the tracking component 310, or one or more components of tracking component 310, can be located at another computer device, such as another server device, a client device, and/or the like.

The one or more input devices 306 can comprise one or more computerized devices, which can include, but are not limited to: personal computers, desktop computers, laptop computers, cellular telephones (e.g., smart phones), computerized tablets (e.g., comprising a processor), smart watches, keyboards, touch screens, mice, a combination thereof, and/or the like. The one or more input devices 306 can be employed to enter data into the system 300, thereby sharing (e.g., via a direct connection and/or via the one or more networks 304) said data with the server 302. For example, the one or more input devices 306 can send data to the communications component 312 (e.g., via a direct connection and/or via the one or more networks 304). Additionally, the one or more input devices 306 can comprise one or more displays that can present one or more outputs generated by the system 300 to a user. For example, the one or more displays can include, but are not limited to: cathode tube display (“CRT”), light-emitting diode display (“LED”), electroluminescent display (“ELD”), plasma display panel (“PDP”), liquid crystal display (“LCD”), organic light-emitting diode display (“OLED”), a combination thereof, and/or the like.

In various embodiments, the one or more input devices 306 and/or the one or more networks 304 can be employed to input one or more settings and/or commands into the system 300. For example, in the various embodiments described herein, the one or more input devices 306 can be employed to operate and/or manipulate the server 302 and/or associate components. Additionally, the one or more input devices 306 can be employed to display one or more outputs (e.g., displays, data, visualizations, and/or the like) generated by the server 302 and/or associate components. Further, in one or more embodiments, the one or more input devices 306 can be comprised within, and/or operably coupled to, a cloud computing environment.

The one or more monitoring devices 308 can be employed by the system 300 to translate one or more light rays into one or more electrical signals. For example, the one or more monitoring devices 308 can detect visible light emitted by the one or more antimicrobial coatings in the presence of UV radiation. In one or more embodiments, the one or more monitoring devices 308 can be comprised within one or more light fixtures, wall-mounted devices, surveillance devices, and/or mobile devices. For example, the one or more monitoring devices 308 can be mounted within, and/or onto, one or more light fixtures positioned on a ceiling or wall. In another example, the one or more monitoring devices 308 can be comprised within one or more wall-mounted devices, such as a device plugged into an electrical outlet. In a further example, the one or more monitoring devices 308 can be comprised within, and/or attached to, various types of surveillance equipment (e.g., cameras and/or motion sensors). In an additional example, the one or more monitoring devices 308 can be comprised within, integrated with, and/or operatively coupled to one or more mobile devices; such as: a smart phone, a smart tablet, a hand-held sensor, a combination thereof, and/or the like.

In various embodiments, the one or more monitoring devices 308 can monitor one or more surfaces to detect light (e.g., fluorescence) emitted by one or more antimicrobial coatings covering the one or more surfaces. For example, the one or more antimicrobial coatings can absorb UV radiation and emit visible light (e.g., due to one or more tracer compounds in the antimicrobial coatings, as described herein) that can be detected by the one or more monitoring devices 308. In some embodiments, the one or more monitoring devices 308 can monitor a defined space and/or can be positioned by a user of the system 300 to one or more desired locations (e.g., the position of the monitoring device 308 can be fixed or mobile). Additionally, the one or more monitoring devices 308 can generate one or more electrical signals that can characterize, for example: a direction from which the detected light is originating, an intensity level of the detected light, a location of the source of the detected light, a combination thereof, and/or the like.

In one or more embodiments, the one or more monitoring devices 308 can share the electrical signals with the communications component 312 via a direct electrical connection and/or via the one or more networks 304. Additionally, the system 300 can comprise a plurality of monitoring devices 308, where the plurality of monitoring devices 308 can share electrical signals between each other via direct electrical connections and/or the one or more networks 304. The communications component 312 can receive the one or more electrical signals, store the electrical signals in the one or more memories 316, and/or share the electrical signals with various associate components of the tracking component 310.

As shown in FIG. 3, the one or more monitoring devices 308 can comprise one or more light sources 322 and/or cameras 324. In various embodiments, the one or more light sources 322 can be one or more devices that generate light. For example, the one or more light sources 322 can illuminate one or more surfaces targeted for coating with one or more antimicrobial coatings described herein. In accordance with various embodiments described herein, the one or more antimicrobial coatings can comprise one or more antimicrobial compounds and tracer compounds. The light emitted by the one or more light sources 322 can facilitate detection of the one or more tracer compounds by the tracking component 110. For example, the tracer compounds can be fluorescent, and the one or more light sources 322 can generate UV light. Thereby, the one or more tracer compounds can absorb the UV light generated by the one or more light sources 322 and emit light within the visible light spectrum (e.g., light with a wavelength between 380 and 700 nanometers). In various embodiments, the one or more light sources 322 can be black lights. For instance, the light sources 322 can include, for example: a fluorescent black light, an incandescent black light, a mercury vapor black light, a light emitting diode (“LED”) black light, a compact fluorescent light (“CFL”) black light, a combination thereof, and/or the like.

Further, the one or more light sources 322 can be fixed and/or mobile. For example, the one or more light sources 322 can include black light bulbs employed in one or more light fixtures, including, but not limited to: lamps, spot lights, track lighting, task lighting, accent lighting, ceiling fans, sconces, under-cabinet lighting, recessed lighting, a combination thereof, and/or the like. In another example, the one or more light sources 322 can be mobile devices, including, but not limited to: a smartphone attachment, a black light flashlight, a black light wand, a combination thereof, and/or the like. In various embodiments, the one or more light sources 322 can be intervening units, such as electrical switches, that can communicate over the one or more networks 104 and control one or more light generating devices. Further, in various embodiments, the one or more light sources 322 can receive control commands from the control component 314 via the one or more networks 104 and/or direct electrical connections. In accordance with various embodiments described herein, the one or more light sources 322 can be employed to facilitate one or more detection methods (e.g., to facilitate the tracking at 208 and/or the monitoring at 210 of the method 200), including autonomous, computer-implemented methods.

In various embodiments, the one or more cameras 324 can be one or more devices that can capture an image. For example, the one or more cameras 324 can be digital devices that generate data representing an image of one or more objects within the camera's 324 line of the sight. The one or more cameras 324 can record visual images in the form of photographs, film and/or video signals. The images captured by the one or more cameras 324 can regard one or more target surfaces being illuminated by the one or more light sources 322. For example, the one or more cameras 324 can monitor the one or more surfaces targeted for treatment by the antimicrobial coating. As the one or more light sources 322 illuminate the targeted surfaces, the one or more cameras 324 can capture one or more images of the targeted surfaces. If the antimicrobial coating is present on the target surfaces, the one or more tracer compounds can emit visible light in response to the UV light generated by the light sources 322, and the one or more images captured by the cameras 324 can depict the visible light, thereby enabling detection of the antimicrobial composition. In various embodiments, the one or more cameras 324 can be positioned at fixed locations or can be mobile devices. For example, the one or more cameras 324 can be fixed to a structure, including, but not limited to: a ceiling, a wall, a pole, a post, a stand, a dashboard, a combination thereof, and/or the like. In another example, the one or more cameras 324 can be mobile devices, including, but not limited to: a handheld camera, a smartphone, a smart tablet, a wearable camera, a camera mounted to a vehicle (e.g., mounted to a drone), a combination thereof, and/or the like. Example types of cameras 324 can include, but are not limited to: compact cameras, digital single lens reflex (“DSLR”) cameras, mirrorless cameras, action cameras, 360-degree cameras, medium format cameras, film cameras, a combination thereof, and/or the like.

In various embodiments, the one or more optical sensors 326 can be one or more sensors that convert light rays into electrical signals (e.g., sensor data). For example, the one or more optical sensors 326 can include one or more electro-monitoring sensors capable of detecting electromagnetic radiation from the infrared up to the UV spectrum. In one or more embodiments, the one or more optical sensors 326 can detect an amount and/or intensity of nearby light. Example types of optical sensors 326 can include, but are not limited to: photoconductive devices, photovoltaic cell devices, and/or photodiode devices. For example, the one or more optical sensors 326 can utilize waveguide-based optical field and/or evanescent wave-based configurations employed for the measurement of refractive index changes. In one or more embodiments, the one or more optical sensors 326 can be employed by the system 300 to measure fluorescence intensity associated with one or more target surfaces analyzed by the optical sensors 326.

In one or more embodiments, the control component 314 can control the one or more monitoring devices 308. For example, the control component 314 can generate command signals to operate the one or more monitoring devices 308. In various embodiments, the control component 314 can activate, deactivate, and/or orient the one or more monitoring devices 308 to facilitate tracking and/or monitoring of the one or more antimicrobial coatings described herein. In some embodiments, the control component 314 can operate the one or more monitoring devices 308 autonomously (e.g., in response to a trigger, a routine activation, and/or a schedule). In some embodiments, the control component 314 can operate the one or more monitoring devices 308 based on one or more commands entered into the system 300 via the one or more input devices 306.

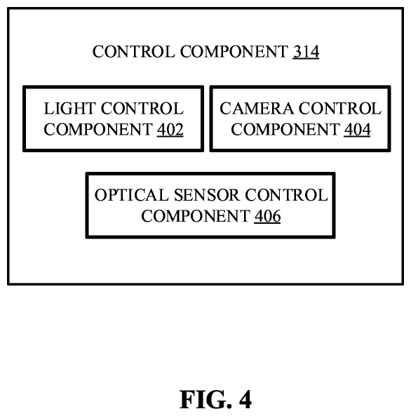

FIG. 4 illustrates a diagram of the example, non-limiting control component 314 further comprising light control component 402, camera control component 404, and/or optical sensor control component 406 in accordance with one or more embodiments described herein. Repetitive description of like elements employed in other embodiments described herein is omitted for sake of brevity.

In various embodiments, the light control component can control the one or more light sources 322 to facilitate detection of the one or more antimicrobial coatings that contain tracer compounds. The light control component 402 can send one or more command signals (e.g., via the one or more networks 304 and/or direct electrical connections) to the one or more light sources 322. The one or more command signals can instruct the one or more light sources 322 to activate or deactivate. In various embodiments the one or more command signals can further instruct the one or more light sources 322 to rotate and/or tilt. For example, the one or more light sources 322 can include a base structure that can enable remote reorientation of the one or more light sources 322. The one or more command signals can control the base structure to adjust the orientation of the one or more light sources 322 and thereby the illumination provided by the light sources 322.

In one or more embodiments, the light control component 402 can activate the one or more light sources 322 and/or orientate the one or more light sources 322 in response to one or more activation requests defined by the one or more input devices 306. For example, the one or more input devices 306 can be employed to initiate operation of the tracking component 110 and/or control illumination provided by the one or more light sources 322 during application of the one or more antimicrobial coatings to the target surfaces and/or post application.

In various embodiments, the camera control component 404 can send one or more command signals (e.g., via the one or more networks 304 and/or direct electrical connections) to the one or more cameras 324. The one or more command signals can instruct the one or more cameras 324 to activate or deactivate. In various embodiments the one or more command signals can further instruct the one or more cameras 324 to rotate and/or tilt. For example, the one or more cameras 324 can include a base structure that can enable remote reorientation of the one or more cameras 324. The one or more command signals can control the base structure to adjust the orientation of the one or more cameras 324 and thereby the monitoring of the one or more target surfaces.

In one or more embodiments, the camera control component 404 can activate the one or more cameras 324 and/or orientate the one or more cameras 324 in response to one or more activation requests defined by the one or more input devices 306. For example, the one or more input devices 306 can be employed to initiate operation of the tracking component 110 and/or control monitoring of the target surfaces during application of the one or more antimicrobial coatings to the target surfaces and/or post application.

In various embodiments, the optical sensor control component 406 can send one or more command signals (e.g., via the one or more networks 304 and/or direct electrical connections) to the one or more optical sensors 326. The one or more command signals can instruct the one or more optical sensors 326 to activate or deactivate. In various embodiments, the one or more command signals can further instruct the one or more optical sensors 326 to rotate and/or tilt. For example, the one or more optical sensors 326 can include a base structure that can enable remote reorientation of the one or more optical sensors 326. The one or more command signals can control the base structure to adjust the orientation of the one or more optical sensors 326 and thereby the monitoring of the one or more target surfaces.

In one or more embodiments, the optical sensor control component 406 can activate the one or more optical sensors 326 and/or orientate the one or more optical sensors 326 in response to one or more activation requests defined by the one or more input devices 306. For example, the one or more input devices 306 can be employed to initiate operation of the tracking component 110 and/or control monitoring of the target surfaces during application of the one or more antimicrobial coatings to the target surfaces and/or post application.

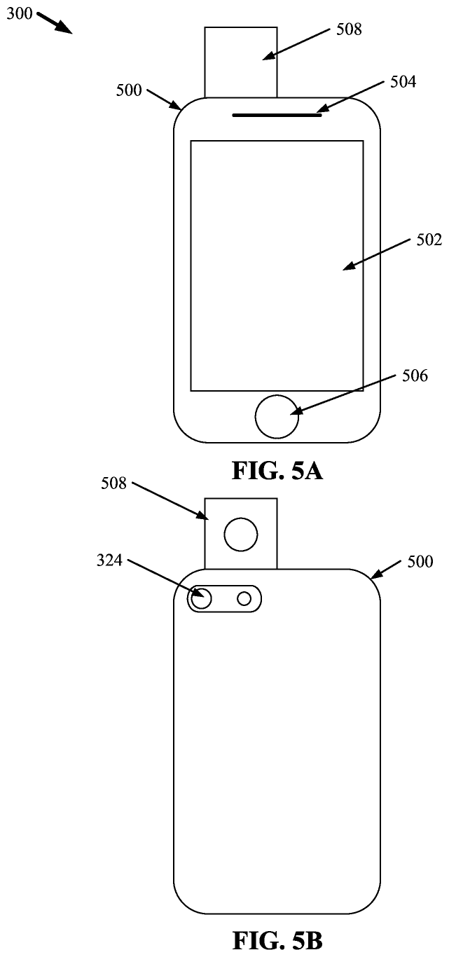

FIGS. 5A and/or 5B illustrate a diagram of the example, non-limiting system 300 embodied in a smartphone architecture in accordance with one or more embodiments described herein. Repetitive description of like elements employed in other embodiments described herein is omitted for sake of brevity. For example, one or more features of server 302 (e.g., the tracking component 110) can be included within a mobile device, such as a smartphone 500. Further, the mobile device (e.g., smartphone 500) can incorporate the one or more input devices 306, light sources 322, and/or cameras 324. Thus, the system 300 can be facilitate by a mobile device (e.g., a smartphone 500) that can be transported to enable detection of the antimicrobial coating at a variety of locations.

In various embodiments, the mobile device can be a smartphone 500, as shown in FIGS. 5A and 5B. However, the architecture of the system 300 is not so limited. For example, embodiments in which the system 300 is incorporated into mobile devices other than a smartphone 500 (e.g., tablets, smart wearables, compact computers, a combination thereof, and/or the like) are also envisaged. FIG. 5A depicts a front side of the exemplary smartphone 500 embodiment. FIG. 5B depicts a back side of the exemplary smartphone 500 embodiment. The exemplary smartphone 500 can include the features, devices, and/or components of all the various embodiments of the system 300 described herein.

As shown in FIG. 5A, the smartphone 500 can comprise a touchscreen 502, microphone 504, and/or one or more buttons 506 to serve as the one or more input devices 306. For example, the touchscreen 502, microphone 504, and/or buttons 506 can be employed to activate one or more computer program applications and/or control the tracking component 310. In one or more embodiments, the one or more light sources 322 can further be attached to the smartphone 500. For instance, the one or more light sources 322 can be a UV light generator 508 that can couple to one or more auxiliary ports of the smartphone 500. For instance, the UV light generator 508 can include, for example: a fluorescent black light, an incandescent black light, a mercury vapor black light, a light emitting diode (“LED”) black light, a compact fluorescent light (“CFL”) black light, a combination thereof, and/or the like. The smartphone 500 can power the UV light generator 508 via the auxiliary port coupling. Additionally, the tracking component 110 (e.g., via light control component 402) can control the UV light generator 508 via the auxiliary port coupling. For example, the light source 322 can be coupled to the smartphone via an auxiliary port, including, but not limited to: a 2.5 millimeter (mm) jack, a 3.5 mm jack, a universal serial bus (“USB”) port, a micro-USB mort, a combination thereof, and/or the like. As shown in FIG. 5B, the UV light generator 508 can be oriented to face the back side of the smartphone 500 to ease operation of the device. Additionally, the smartphone 500 can include one or more cameras 324 (e.g., also orientated on the back side of the smartphone 500).

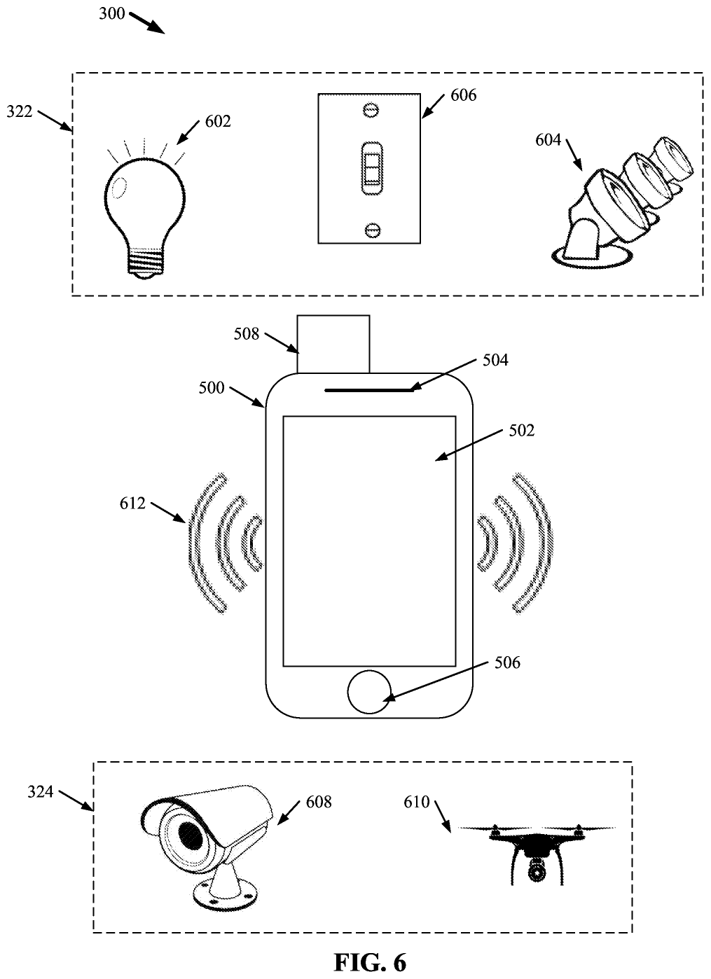

FIG. 6 illustrate a diagram of the example, non-limiting system 300 comprising one or more mobile components and/or devices in combination with one or more fixed components and/or devices. Repetitive description of like elements employed in other embodiments described herein is omitted for sake of brevity. In various embodiments, various features of the system 300 can remain in fixed positions while other features of the system 300 can be incorporated into one or more mobile devices. For example, one or more light sources 322 and/or cameras 324 can remain in a fixed position within a space, while the one or more input devices 306 and/or servers 302 can be mobile and can communicated with the fixed features remotely (e.g., via the one or more networks 104). Additionally, the one or more light sources 322 can include one or more fixed devices and one or more mobile devices. Likewise, the one or more cameras 324 can include one or more fixed devices and one or more mobile devices.

In various embodiments, the one or more input devices 306 and/or servers 302 can be housed within a mobile device, such as smartphone 500. The one or more light sources 322 can include devices incorporated into the mobile device (e.g., such as UV light generator 508) and one or more external devices. Exemplary external light source 322 devices can include, but are not limited to: black light bulbs 602, black light fixtures 604, electrical switches 606, a combination thereof, and/or the like. For example, FIG. 6 depicts an exemplary embodiment of system 300 in which the smartphone 500 can be employed to execute the tracking component 110 and control one or more light sources 322 from a plurality of light sources 322 that can be either directly coupled to the smartphone 500 (e.g., UV light generator 508) and/or wirelessly coupled to the smartphone 500 (e.g., black light bulb 602, black light fixture 604, and/or electrical switch 606).

In one or more embodiments, the one or more antimicrobial coatings described herein can be deposited onto the one or more target surfaces using an electrostatic sprayer. Further, the electrostatic sprayer can include one or more of the light sources 322. For example, one or more light sources 322 incorporated into a handle of the electrostatic sprayer can illuminate the target surface area as the antimicrobial coating is being deposited. Further, the electrostatic sprayer light source 322 can be controlled via the light control component 402 to monitor coverage of the antimicrobial coating on the target surface during the deposition.

Likewise, the one or more cameras 324 can include devices incorporated into the mobile device (e.g., such as a smartphone 500 camera) and one or more external devices. External camera 324 devices can include, but are not limited to: mounted cameras 608, mobile cameras 610 (e.g., including cameras that are worn, carried, and/or mounted on a vehicle, such as drone), a combination thereof, and/or the like. For example, FIG. 6 depicts an exemplary embodiment of system 300 in which the smartphone 500 can be employed to execute the tracking component 110 and control one or more cameras 324 from a plurality of cameras 324 that can be either directly coupled to the smartphone 500 and/or wirelessly coupled to the smartphone 500 (e.g., mounted cameras 608 and/or mobile cameras 610).

As shown in FIG. 6, the mobile device (e.g., exemplary smartphone 500) can further the tracking component 110 and associate components thereof; including, for example, the control component 314, which can send one or more command signals 612 to the various light sources 322 and/or cameras 324. For example, the smartphone 500 can communicate the one or more command signals 612 wirelessly to the one or more light sources 322 and/or cameras 324 via one or more networks 304. In accordance with the various embodiments described herein, the one or more command signals 612 can activate, deactivate, and/or orient the one or more light sources 322 and/or cameras 324. In various embodiments, the one or more light sources 322 and/or cameras 324 can also wirelessly transmit data to the smartphone 500. For example, the one or more cameras 324 can wirelessly communicate image data to the smartphone 500 over the one or more networks 304.

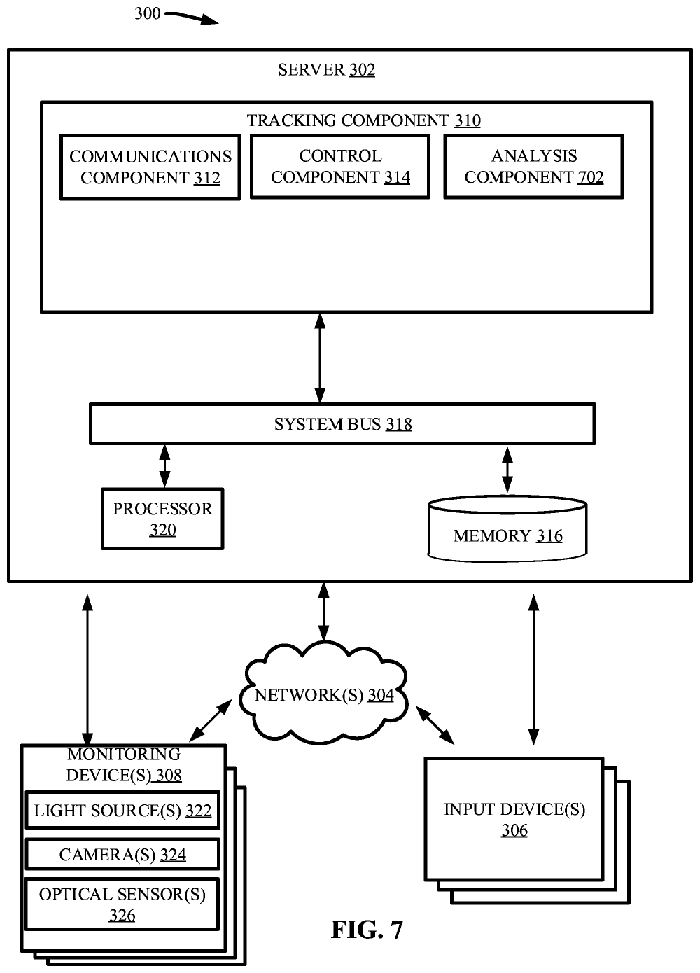

FIG. 7 illustrates a diagram of the example, of the non-limiting system 300 further comprising analysis component 702 in accordance with one or more embodiments described herein. Repetitive description of like elements employed in other embodiments described herein is omitted for sake of brevity. In various embodiments, the analysis component 702 can analyze image data generated by the one or more cameras 324 regarding one or more target surfaces illuminated by the one or more light sources 322.

In various embodiments, where a target surface is coated with an antimicrobial coating described herein, a tracer compound (e.g., a fluorescent compound) in the antimicrobial coating can be detected in the presence of the light provided by the one or more light sources 322. For example, the tracer compound can be one or more fluorescent compounds that can emit visible light in response to absorbing UV light emitted by the one or more light sources 322. The one or more cameras 324 can generate image data characterizing the target surface and thereby visible light emitted from the tracer compound located on the target surface.

Further, the analysis component 702 can analyze the image data to determine where light emitted by the tracer compounds is detected. For example, where the antimicrobial coating is present at a first region of the target surface, the image data generated by the one or more cameras 324 can depict the light emitted by the one or more tracer compounds in the first region. In contrast, where the antimicrobial coating is absent from a second region of the target surface, the image data generated by the one or more cameras 324 can depict a lack of emitted light from the second region.

In various embodiments, the analysis component 702 can identify light emitted by the one or more tracer compounds and represented in the image data based on the color of the light. For example, the one or more tracer compounds can emit visible light having a defined wavelength, and thereby a defined color. Thus, the analysis component 702 can scan the image data to identify light of the defined wavelength and/or color. Further, the analysis component 702 can define one or more regions of the image characterized by the image data based on the color of light, or lack of light, associated with the region.

For example, one or more first regions defined by the analysis component 702 can be regions of the image that have the visible light of the defined wavelength and/or color. Additionally, one or more second regions defined by the analysis component 702 can be regions of the image that do not have the visible light of the defined wavelength and/or color. Thus, the one or more first regions can be regions of the image where the antimicrobial coating is present, and the one or more second regions can be regions of the image where the antimicrobial coating is not present. In various embodiments, the control component 314 can control the one or more light sources 322 such that the one or more target surfaces are only, or substantially, illuminated with UV light. For example, the control component 314 can deactivate one or more light sources 322 that typically illuminate the one or more target surfaces with light outside the UV spectrum (e.g., visible light), and operate (e.g., activate and/or alter) one or more light sources 322 to illuminate the one or more target surfaces with UV light. Thus, where the one or more cameras 324 capture visible light in association with one or more regions of the target surfaces, the analysis component 702 can associate the visible light as light emitted by the one or more tracer compounds of the antimicrobial coating (e.g., at least due to the minimization of alternate visible light sources).

Thus, the image data generated by the one or more cameras 324 can characterize an image of the one or more target surfaces. Where the one or more tracer compounds are present on the target surfaces, their presence can be indicated by the emission of light having defined wavelength, which can in turn be detected by the one or more cameras 324 and represented in image data. The analysis component 702 can analyze the image data to identify regions of the image that have light of the defined wavelength and define said regions as regions associated with the presence of the one or more tracer compounds. Thereby, the analysis component 702 can determine where the tracer compound is located within the image and where the tracer compound is not located.

In various embodiments, the analysis component 702 can further implement one or more artificial intelligence (“AI”) technologies (e.g., machine learning technologies) to identify and/or classify objects within the image (e.g., objects characterized by the image data). For example, the analysis component 702 can employ AI technology to identify portions of the image associated with the one or more target surfaces. In another example, the analysis component 702 can employ AI technology to identify persons, animals, and/or objects that are not the one or more target surfaces.

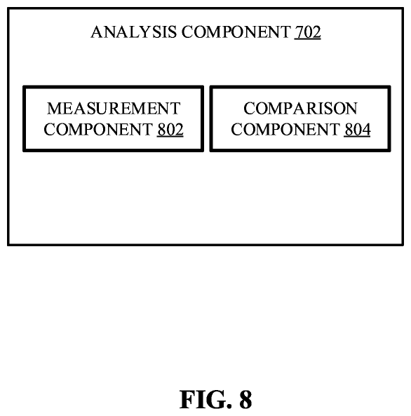

FIG. 8 illustrates a diagram of the example, non-limiting analysis component 702 further comprising measurement component 802 and/or comparison component 804 in accordance with one or more embodiments described herein. Repetitive description of like elements employed in other embodiments described herein is omitted for sake of brevity. In various embodiments, the measurement component 802 can analyze the electrical signals (e.g., image data and/or sensor data) captured by the one or more monitoring devices 308 (e.g., cameras 324 and/or optical sensors 326) to determine an amount of light and/or an intensity of light emitted by the one or more antimicrobial coatings and/or detected by the one or more monitoring devices 308 (e.g., cameras 324 and/or optical sensors 326).

In one or more embodiments, the measurement component 802 can determine the amount and/or intensity of the detected light by comparing the electrical signals (e.g., image data and/or sensor data) to reference data characterizing the monitored space absent light emitted by the one or more antimicrobial coatings. For example, additional light, as compared to the reference data, can be attributed to light emitted by the one or more antimicrobial coatings. In various embodiments, the measurement component 802 can analyze the electrical signals (e.g., image data and/or sensor data) to determine an amount and/or intensity of detected light characterized by a defined wavelength. For example, the defined wavelength can be a wavelength associated with light emitted from the one or more or more antimicrobial coatings. For instance, the one or more antimicrobial coatings can include one or more tracer compounds that emit the defined wavelength of light in response to absorbing UV radiation. Thus, by identifying which light rays detected by the one or more monitoring devices 308 (e.g., cameras 324 and/or optical sensors 326) are characterized by the defined wavelength, the measurement component 802 can identify which light rays detected by the one or more monitoring devices 308 (e.g., cameras 324 and/or optical sensors 326) are associated with the one or more antimicrobial coatings. Additionally, in one or more embodiments, the measurement component 802 can analyze the one or more electrical signals (e.g., image data and/or sensor data) to identify one or more portions of the space monitored by the one or more monitoring devices 308 as sources for the detected light.

In various embodiments, the comparison component 804 can compare the amount and/or intensity of light determined by the measurement component 802 with one or more degradation thresholds to determine an amount of degradation associated with the one or more antimicrobial coatings.

In one or more embodiments, one or more degradation thresholds can be stored in the one or more memories 316. The one or more degradation thresholds can define an amount and/or intensity of light associated with a specified amount of degradation of the one or more antimicrobial coatings. The comparison component 804 can compare the one or more determinations generated by the measurement component 802 with the one or more degradation thresholds to determine an amount of degradation experienced by the one or more antimicrobial coatings. For example, wherein a first degradation threshold is associated with 25 percent degradation of the one or more antimicrobial coatings; the comparison component 804 can determine that the one or more antimicrobial coatings have degraded by at least 25 percent based on the amount and/or intensity of light determined by the measurement component 802 being less than the first degradation threshold. In various embodiments, degradation of the one or more antimicrobial coatings can be a result of the one or more antimicrobial coatings aging and/or being removed from the one or more target surfaces.

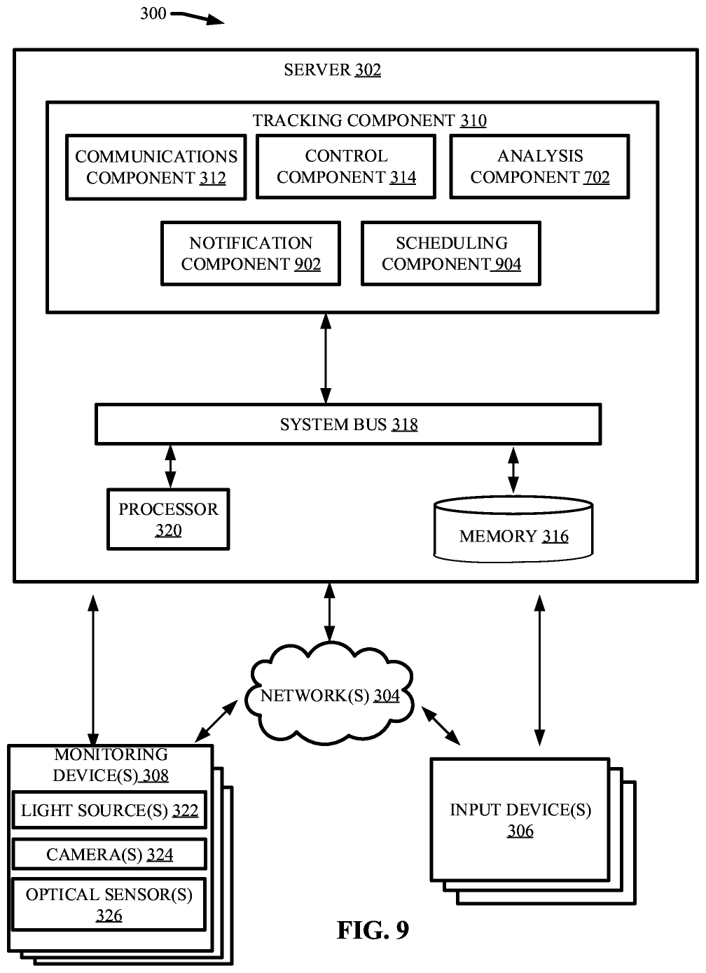

FIG. 9 illustrates a diagram of the example, non-limiting system 300 further comprising notification component 902 and/or scheduling component 904 in accordance with one or more embodiments described herein. Repetitive description of like elements employed in other embodiments described herein is omitted for sake of brevity. In various embodiments, the notification component 902 can generate one or more notifications regarding the coverage and/or degradation of the antimicrobial coating on the one or more target surfaces based on the determinations made by the analysis component 702. The one or more notifications generated by the notification component 902 can include, for example: text, images, audio recordings, graphs, diagrams, charts, interactive illustrations, maps, tables, videos, a combination thereof, and/or the like.

In one or more embodiments, the notification component 902 can generate one or more notifications regarding the coverage of the antimicrobial coating on the one or more target surfaces. For example, the notification component 902 generate one or more notifications that delineate the size and/or position of the one or more second regions defined by the analysis component 702 (e.g., area of regions associated with the absence of light of the defined wavelength and thereby lack the tracer compound) with respect to the image captured by the one or more cameras 324. A user of the system 300 can employ the one or more input devices 306 to view the notification and thereby identifying target surfaces, or portions of target surfaces, that lack the antimicrobial coating.

In one or more embodiments, the notification component 902 can generate one or more notifications regarding coverage of the antimicrobial coating in response to an amount of antimicrobial coating coverage falling below a defined coverage threshold. For example, the notification component 902 can compare the area of the first regions defined by the analysis component 702 (e.g., area of regions associated with light of the defined wavelength and thereby regions that include the tracer compound) with the area of the second regions defined by the analysis component 702. Where the area of the first regions is less than the area of the second regions, the notification component 902 can generate one or more notifications. In another example, the notification component 902 can define the area of the first regions (e.g., defined by the analysis component 702) as a percentage of the total area of the image. Where the percentage of image area associated with the one or more first regions is less than a defined coverage threshold (e.g., less than 75 percent), the notification component 902 can generate a notification advising the application of more of the antimicrobial coating. In various embodiments, the one or more input devices 306 can be employed to set value of the defined coverage threshold.

In one or more embodiments, the notification component 902 can also generate one or more degradation alerts that can describe the level of degradation experienced by the one or more antimicrobial coatings based on the one or more comparisons made by the comparison component 804. The notification component 902 can generate the one or more degradation alerts based on the comparison component 804 determining that the amount and/or intensity of detected light determined by the measurement component 802 being less than a given degradation threshold. In various embodiments, the one or more input devices 306 can be employed to define which degradation thresholds can trigger generation of the one or more degradation alerts. Further, the notification component 902 can share the one or more notifications (e.g., coverage alerts and/or degradation alerts) with the one or more input devices 306 via a direct electrical connection and/or the one or more networks 304. A user of the system 300 can be notified on the one or more degradation alerts, and thereby informed regarding the amount of degradation experienced by the one or more antimicrobial coatings, via the one or more input devices 306.

In various embodiments, the scheduling component 904 can generate one or more schedules regarding operation of the one or more monitoring devices 308, control component 314, and/or analysis component 702 and/or regarding the application of the antimicrobial coatings on the one or more target surfaces. In one or more embodiments, the scheduling component 904 can generate one or more tracking schedules that can define: when the light control component 402 activates the one or more light sources 322; when the camera control component 404 activates the one or more cameras 324; and/or when the analysis component 702 analyzes the electrical signals generated by the monitoring devices 308 (e.g., image data and/or sensor data). For example, the presence of antimicrobial coating on the one or more target surfaces can be tracked periodically in accordance with one or more tracking schedules generated by the scheduling component 904. For instance, the control component 314 and/or analysis component 702 can automatically perform their respective features at defined time intervals (e.g., every five days, each month, every six months, and/or the like) and/or at a defined time. Additionally, the one or more input devices 306 can be employed to define one or more time intervals and/or time frames implemented by the tracking schedule.

In one or more embodiments, the scheduling component 904 can generate one or more application schedules that can define when the antimicrobial coating will be applied to the one or more target surfaces. For example, the scheduling component 904 can automatically schedule an application of antimicrobial coating to the one or more target surfaces in response to a degradation alert generated by the notification component 902. In various embodiments, the scheduling component 904 can further share the application schedule with one or more other scheduling systems to facilitate reserving the antimicrobial coating application services. Thereby, the system 300 can autonomously monitor the coverage of the antimicrobial coatings on the target surfaces and schedule re-applications of the antimicrobial coating as the antimicrobial coating deteriorates from the target surfaces.

In various embodiments, the system 300 can be employed in conjunction with method 100 and/or method 200 to autonomously monitor the one or more antimicrobial coatings on the one or more surfaces. The one or more antimicrobial coatings can be applied to one or more surfaces in accordance with method 100 and/or 200 and in proximity to the one or more monitoring devices 308. For instance, the one or more surfaces coated with the one or more antimicrobial coatings can be positioned in a room, vehicle, enclosure, and/or space outfitted with the one or more monitoring devices 308. Further, the one or more input devices 306 can be employed to set a monitoring schedule that delineates when and/or how often degradation of the antimicrobial coatings is monitored. In another instance, the one or more monitoring devices 308 can be comprised within one or more mobile devices (e.g., handheld devices) and can be transported into proximity of the one or more surfaces at a time of degradation monitoring.

In a further instance, the one or more antimicrobial coatings can be applied to one or more wall mounted devices comprising the one or more of the monitoring devices 308 in addition to the one or more target surfaces. For example, the one or more wall mounted devices can comprise a sample surface that can be monitored by the one or more monitoring devices 308. During application of the one or more antimicrobial coatings to the one or more target surfaces, the one or more antimicrobial coatings can be further applied to the sample surface. Wherein the sample surface is in proximity to the one or more target surfaces, antimicrobial coating degradation experienced on the sample surface can be akin to antimicrobial coating degradation experienced on the one or more target surfaces. Thereby, the one or more monitoring devices 308 can monitor the one or more target surfaces by monitoring the one or more sample surfaces.

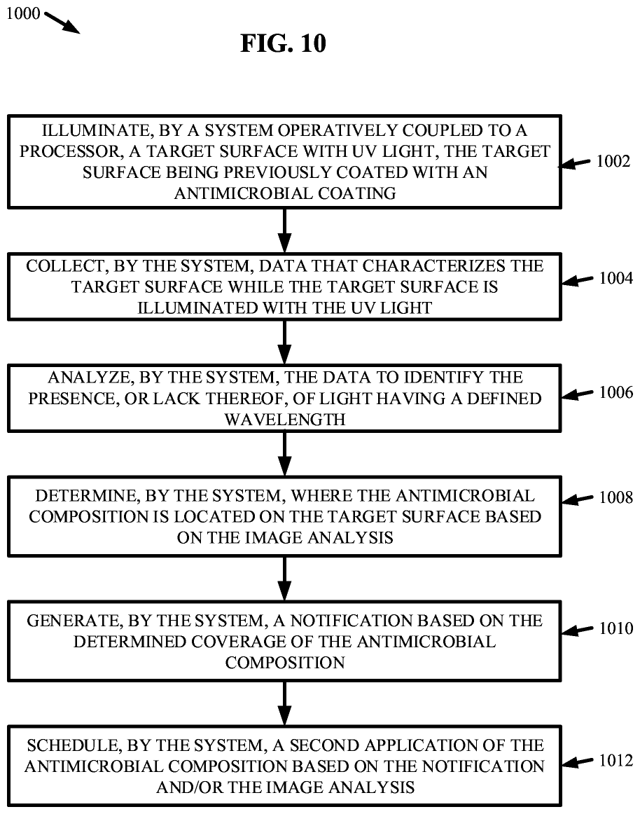

FIG. 10 illustrates a flow diagram of an example, non-limiting computer-implemented method 1000 that can facilitate autonomous tracking and/or monitoring the coverage of one or more antimicrobial coatings on one or more target surfaces in accordance with one or more embodiments described herein. Repetitive description of like elements employed in other embodiments described herein is omitted for sake of brevity.

At 1002, the computer-implemented method 1000 can comprise illuminating (e.g., via one or more light sources 322), by a system 300 operatively coupled to a processor 320, one or more target surfaces with UV light, where the one or more target surface can be previously coated with one or more antimicrobial coatings. As described herein, the one or more antimicrobial coatings can comprise one or more tracer compounds (e.g., fluorescent compounds) in addition to one or more antimicrobial compounds. In various embodiments, the light control component 402 can control one or more light sources 322 to generate the UV light at 1002. Further, the light control component 402 can activate and/or orient one or more of the light sources 322 to facilitate the illuminating at 1002.

At 1004, the computer-implemented method 1000 can comprise collecting (e.g., via one or more cameras 324 and/or optical sensors 326), by the system 100, data (e.g., image data and/or sensor data) that can characterize the one or more target surfaces while the one or more target surfaces are being illuminated with the UV light. For example, the camera control component 404 can control one or more cameras 324 to generate image data representing images of the one or more target surfaces. In various embodiments, the camera control component 404 can activate and/or orient one or more of the cameras 324 to facilitate the image capturing at 1004. In another example, the one or more optical sensors 326 can detect light associated with the one or more target surfaces and covert the light rays into sensor data characterizing an amount and/or intensity of the light.

At 1006, the computer-implemented method 1000 can comprise analyzing (e.g., via analysis component 702), by the system 100, the data (e.g., image data and/or sensor data) to identify the presence, or lack thereof, of light having a defined wavelength. In various embodiments, the defined wavelength can be the wavelength of light emitted by the one or more tracer compounds in response to UV light.

For example, the analysis component 702 can analyze image data collected from the one or more cameras 324 to determine whether light is being emitted from the one or more target surfaces and/or which regions of the target surfaces are emitting light, if any. For instance, illumination of the one or more target surfaces can be controlled (e.g., via control component 314) such that the target surfaces are only illuminated with, or substantially illuminated with, UV light. Thus, the analysis component 702 can associate visible light detected in the image data of the one or more cameras 324 with light emitted by the one or more tracer compounds, and thereby the presence of antimicrobial coating. In another instance, image data captured by the one or more cameras 324 can be compared to reference image data. The reference image data can characterize the one or more target surfaces when the target surfaces are not illuminated with UV light. Thereby, the presence of additional visible light (e.g., of a defined wavelength and/or color) in the image data can be associated with light emitted by the one or more tracer compounds, and thereby the presence of antimicrobial coating.

In another example, the analysis component 702 can analyze sensor data collected from the one or more optical sensors 326 to determine whether light is being emitted from the one or more target surfaces and/or which regions of the target surfaces are emitting light, if any. For instance, the one or more optical sensors 326 can be positioned adjacent to the one or more target surfaces and can generate sensor data characterizing the amount and/or intensity of light being emitted and/or reflected by the one or more target surfaces. Where the amount and/or intensity of light characterized by the sensor data exceeds one or more thresholds, the analysis component 702 can determine that the one or more target surfaces are emitting visible light in response to the UV illumination, and thereby the one or more target surfaces are coated with the antimicrobial coating having the one or more tracer compounds.

At 1008, the computer-implemented method 1000 can comprise determining (e.g., via analysis component 702), by the system 300, where the antimicrobial coating is located on the one or more target surfaces based on the analyzing at 1006. For example, the analysis component 702 can identify one or more first regions of the image data that include light of the defined wavelength and one or more second regions of the image data that lack light of the defined wavelength. Further analysis component 702 can determine that the antimicrobial coating is located within the one or more first regions and absent from the one or more second regions.

At 1010, the computer-implemented method 1000 can comprise generating (e.g., via notification component 902), by the system 300, one or more notifications based on the determined coverage of the antimicrobial coating. For example, the notification component 902 can generate one or more notifications regarding the presence, or lack thereof, of antimicrobial coating on the one or more target surfaces based on the determinations made at 1006 and/or 1008. At 1012, the computer-implemented method 1000 can comprise scheduling (e.g., via scheduling component 904), by the system 300, one or more second applications of the antimicrobial coating based on the notifications generated at 1010 and/or the determinations made at 1006-1008 in accordance with one or more embodiments described herein.

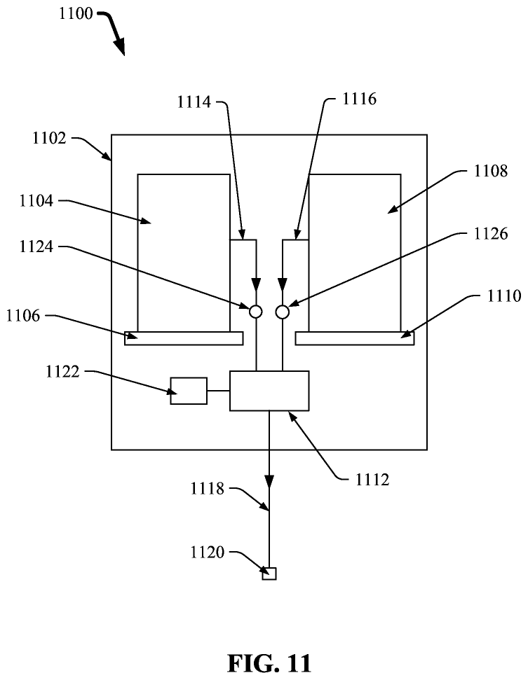

FIG. 11 illustrates a diagram of an example, non-limiting disbursement backpack 1100 that can contain the one or more tracer chemical compositions and/or antimicrobial chemical compositions to facilitate disbursement of the one or more antimicrobial coatings in accordance with one or more embodiments described herein. Repetitive description of like elements employed in other embodiments described herein is omitted for sake of brevity. In various embodiments, the disbursement backpack 1100 can comprise a main housing 1102 that can further comprise a first fluid reservoir 1104 removably attached to a first reservoir seat 1106 and/or a second fluid reservoir 1108 removably attached to a second reservoir seat 1110. Example materials that can compose the main housing 1102 can include, but are not limited to: plastics, neoprene materials and/or derivatives, polymers, elastic polymers, synthetic fibers, cloth, a combination thereof, and/or the like.

In various embodiments, the first fluid reservoir 1104 can house the one or more tracer chemical compositions. Additionally, the second fluid reservoir 1108 can house the one or more antimicrobial chemical compositions. One of ordinary skill in the art will recognize that the size and/or shape of the first fluid reservoir 1104 and/or the second fluid reservoir 1108 can vary depending on the size and/or shape the main housing 1102. For example, while FIG. 11 depicts the first fluid reservoir 1104 and/or the second fluid reservoir 1108 having a rectangular shape, circular and/or polygonal shapes are also envisaged. Additionally, while FIG. 11 depicts the first fluid reservoir 1104 and the second fluid reservoir 1108 having the same shape and/or volume, embodiments wherein the first fluid reservoir 1104 and the second fluid reservoir 1108 having different shapes and/or volumes are also envisaged.

The first reservoir seat 1106 and/or the second reservoir seat 1110 can be fixed to the main housing 1102 and can provide structural support to the first fluid reservoir 1104 and/or the second fluid reservoir 1108. In various embodiments, the first fluid reservoir 1104 can be removably attachable to the first reservoir seat 1106 such that the first fluid reservoir 1104 can be removed from the disbursement backpack 1100 to be refilled and/or replaced. Likewise, the second fluid reservoir 1108 can be removably attachable to the second reservoir seat 1110 such that the second fluid reservoir 1108 can be removed from the disbursement backpack 1100 to be refilled and/or replaced. For example, the first fluid reservoir 1104 and/or the second fluid reservoir 1108 can be removably attached to the first reservoir seat 1106 and/or the second reservoir seat 1110 via a clip and/or screw mechanism. In one or more embodiments, the first reservoir seat 1106 and/or the second reservoir seat 1110 can extend along the sides of the first fluid reservoir 1104 and/or the second fluid reservoir 1108 so as to provide additional structural support. For example, the first reservoir seat 1106 and/or the second reservoir seat 1110 can be pockets and/or pouches having shapes that complement the shapes of the first fluid reservoir 1104 and/or the second fluid reservoir 1108.

The first fluid reservoir 1104 can be in fluid communication with a pump 1112 via one or more first inlet conduits 1114. The one or more first inlet conduits 1114 can be, for example, one or more tubes in fluid communication with the first fluid reservoir 1104. In various embodiments, the one or more first inlet conduits 1114 can be removably attached to the first fluid reservoirs 1104. The one or more first inlet conduits 1114 can be removably attached to a side of the first fluid reservoir 1104 and/or a top of the first fluid reservoir 1104. Additionally, the one or more first inlet conduits 1114 can extend from the first fluid reservoir 1104 to a pump 1112 that can be housed by the main housing 1102.

The second fluid reservoir 1108 can be in fluid communication with the pump 1112 via one or more second inlet conduits 1116. The one or more second inlet conduits 1116 can be, for example, one or more tubes in fluid communication with the second fluid reservoir 1108. In various embodiments, the one or more second inlet conduits 1116 can be removably attached to the second fluid reservoirs 1108. The one or more second inlet conduits 1116 can be removably attached to a side of the second fluid reservoir 1108 and/or a top of the second fluid reservoir 1108. Additionally, the one or more second inlet conduits 1116 can extend from the second fluid reservoir 1108 to the pump 1112.

The pump 1112 can be in further fluid communication with one or more outlet conduits 1118. The one or more outlet conduits 1118 can extend through and/or beyond the boundaries of the main housing 1102. Further, one or more couplings 1120 can be fixed to a distal end of the one or more outlet conduits 1118. The one or more couplings 1120 can be configured to operatively couple the one or more outlet conduits 1118 to one or more sprayer devices. For example, the one or more couplings 1120 can be configured to operatively couple the one or more outlet conduits 1118 to one or more electrostatic sprayers.

In various embodiments, the pump 1112 can create a first pressure differential in the first fluid reservoir 1104 to draw the tracer chemical composition out of the first fluid reservoir 1104, into the one or more first inlet conduits 1114, and through the one or more outlet conduits 1118. Additionally, the pump 1112 can create a second pressure differential in the second fluid reservoir 1108 to draw the antimicrobial chemical composition out of the second fluid reservoir 1108, into the one or more second inlet conduits 1116, and through the one or more outlet conduits 1118. Moreover, the first and second pressure differentials can be equal or unequal.

In one or more embodiments, the pump 1112 can draw the tracer chemical composition and the antimicrobial chemical composition simultaneously into the one or more outlet conduits 1118. Thereby, the one or more tracer chemical compositions and/or antimicrobial chemical compositions can mix within the one or more outlet conduits 1118 and form the one or more antimicrobial coatings within the one or more outlet conduits 1118. By varying the first and/or second pressure differentials, the pump 1112 can alter the amount of fluid expelled by the first fluid reservoir 1104 and/or the second fluid reservoir 1108 respectively during a defined period of time. Thereby, the pump 1112 can modulate the first and second pressure differentials to control the chemical composition of the antimicrobial coatings formed in the one or more outlet conduits 1118.

In various embodiments, the pump 1112 can be operably coupled to a control unit 1122 that can manage operation of the pump 1112 and/or set the first pressure differential and/or the second pressure differential based on, for example: a target antimicrobial coating composition, a length and/or diameter of the first inlet conduit 1114, a length and/or diameter of the second inlet conduit 1116, a volume of the first fluid reservoir 1104, a volume of the second fluid reservoir 1108, a combination thereof, and/or the like. In one or more embodiments, the control unit 1122 can comprise a processor (e.g., a, central processing unit, a microprocessor, and/or the like) and/or one or more computer executable programs stored within one or more memories to execute one or more algorithms that determine the first pressure differential and/or the second pressure differential.

Additionally, the control unit 1122 can be in communication (e.g., wired or wireless communication) with a first pressure sensor 1124 and/or a second pressure sensor 1126. The first pressure sensor 1124 can monitor the pressure in the one or more first inlet conduits 1114, and the second pressure sensor 1126 can monitor the pressure in the one or more second inlet conduits 1116. In various embodiments, the control unit 1122 can alter the first pressure differential and/or the second pressure differential based on the monitored pressure values in the one or more first inlet conduits 1114 and/or second inlet conduits 1116.

In one or more embodiments, the first fluid reservoir 1104 and/or the second fluid reservoir 1108 can further comprise one or more radio-frequency identification (“RFID”) chips that can be read by the control unit 1122. For example, the RFID chips can communicate information to the control unit 1122 regarding the contents of the reservoirs (e.g., such as the composition of the tracer chemical composition and/or the antimicrobial composition). The control unit 1122 can set the first and/or second pressure differential based further on the information conveyed by the one or more RFID chips. Thereby, the control unit 1122 can adjust the first differential pressure and/or the second differential pressure based on exchange of the first fluid reservoir 1104 or the second fluid reservoir 1108 with one or more reservoirs containing different chemical compositions that previously utilized.

Moreover, in various embodiments the main housing 1102 can comprise one or more power sources (e.g., batteries) that can supply electricity to the control unit 1122 and/or pump 1112. Further, the main housing 1102 can comprise one or more vents and/or fans to facilitate operation of the control unit 1122 and/or pump 1112.

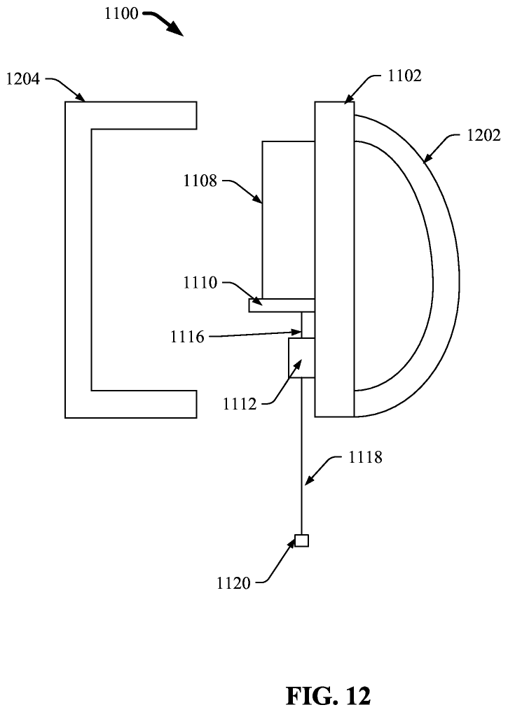

FIG. 12 illustrates a diagram of an example, non-limiting side view of the disbursement backpack 1100 that can contain the one or more tracer chemical compositions and/or antimicrobial chemical compositions to facilitate disbursement of the one or more antimicrobial coatings in accordance with one or more embodiments described herein. Repetitive description of like elements employed in other embodiments described herein is omitted for sake of brevity. In various embodiments, the disbursement backpack 1100 can further comprise one or more harnesses 1202 attached to the main housing 1102. As shown in FIG. 12, the one or more harnesses 1202 can be one or more straps that can facilitate carrying the disbursement backpack 1100 on an individual's back. By carrying the disbursement backpack 1100 on the user's back, the weight of the fluid compositions (e.g., tracer chemical compositions and/or antimicrobial chemical compositions) can be supported by the user's legs. Thereby, the user can utilize larger volumes of antimicrobial coating without placing an undue burden on the user's upper body (e.g., arms).

In one or more embodiments, the disbursement backpack 1100 can further comprise one or more housing covers 1204. The one or more housing covers 1204 can be removably attached to the main housing 1102. For example, FIG. 12 depicts the disbursement backpack 1100 in which the housing cover 1204 is detached from the main housing 1102. When attached to the disbursement backpack 1100, the one or more housing covers 1204 can surround the first fluid reservoir 1104, first reservoir seat 1106, second fluid reservoir 1108, second reservoir seat 1110, pump 1112, first inlet conduit 1114, second inlet conduit 1116, a portion of the outlet conduit 1118, control unit 1122, first pressure sensor 1124, and/or second pressure sensor 1126. Thereby, the one or more housing covers 1204 can protect the various features of the disbursement backpack 1100. Additionally, the one or more housing covers 1204 can be removed from the main housing 1102 to facilitate access to one or more features of the disbursement backpack 1100. The one or more housing covers 1204 can be removable attached to the main housing 1102 via one or more hinges, hooks, tongue and groove configurations, screws, fasteners, clips, a combination thereof, and/or the like.

In various embodiments, the disbursement backpack 1100 can be operably coupled to one or more electrostatic sprayers (e.g., via couplings 1120) to facilitate disbursement of the one or more antimicrobial coatings in accordance with method 100 and/or method 200. One of ordinary skill in the art will recognize that the disbursement backpack 1100 can be coupled to and/or decoupled from various electrostatic sprayers during disbursement of the antimicrobial coating to meet changing demands in the application process, wherein the selection of respective electrostatic sprayers can be chosen based on the context of the application.

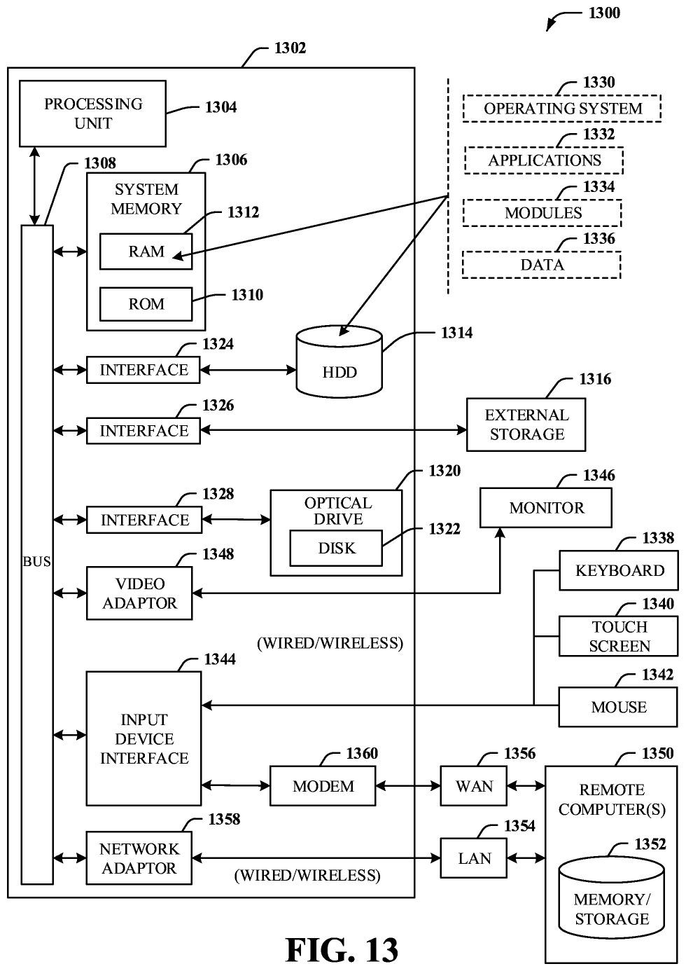

In order to provide additional context for various embodiments described herein, FIG. 13 and the following discussion are intended to provide a brief, general description of a suitable computing environment 1300 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (“IoT”) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices. For example, in one or more embodiments, computer executable components can be executed from memory that can include or be comprised of one or more distributed memory units. As used herein, the term “memory” and “memory unit” are interchangeable. Further, one or more embodiments described herein can execute code of the computer executable components in a distributed manner, e.g., multiple processors combining or working cooperatively to execute code from one or more distributed memory units. As used herein, the term “memory” can encompass a single memory or memory unit at one location or multiple memories or memory units at one or more locations.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (“RAM”), read only memory (“ROM”), electrically erasable programmable read only memory (“EEPROM”), flash memory or other memory technology, compact disk read only memory (“CD-ROM”), digital versatile disk (“DVD”), Blu-ray disc (“BD”) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 13, the example environment 1300 for implementing various embodiments of the aspects described herein includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi-processor architectures can also be employed as the processing unit 1304.

The system bus 1308 can be any of several types of bus structure that can further interconnect to a memory bus (with or without a memory controller), a peripheral bus, and a local bus using any of a variety of commercially available bus architectures. The system memory 1306 includes ROM 1310 and RAM 1312. A basic input/output system (“BIOS”) can be stored in a non-volatile memory such as ROM, erasable programmable read only memory (“EPROM”), EEPROM, which BIOS contains the basic routines that help to transfer information between elements within the computer 1302, such as during startup. The RAM 1312 can also include a high-speed RAM such as static RAM for caching data.

The computer 1302 further includes an internal hard disk drive (“HDD”) 1314 (e.g., EIDE, SATA), one or more external storage devices 1316 (e.g., a magnetic floppy disk drive (“FDD”) 1316, a memory stick or flash drive reader, a memory card reader, etc.) and an optical disk drive 1320 (e.g., which can read or write from a CD-ROM disc, a DVD, a BD, etc.). While the internal HDD 1314 is illustrated as located within the computer 1302, the internal HDD 1314 can also be configured for external use in a suitable chassis (not shown). Additionally, while not shown in environment 1300, a solid state drive (“SSD”) could be used in addition to, or in place of, an HDD 1314. The HDD 1314, external storage device(s) 1316 and optical disk drive 1320 can be connected to the system bus 1308 by an HDD interface 1324, an external storage interface 1326 and an optical drive interface 1328, respectively. The interface 1324 for external drive implementations can include at least one or both of Universal Serial Bus (“USB”) and Institute of Electrical and Electronics Engineers (“IEEE”) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1302, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. The systems and methods described herein can be implemented utilizing various commercially available operating systems or combinations of operating systems.

Computer 1302 can optionally comprise emulation technologies. For example, a hypervisor (not shown) or other intermediary can emulate a hardware environment for operating system 1330, and the emulated hardware can optionally be different from the hardware illustrated in FIG. 13. In such an embodiment, operating system 1330 can comprise one virtual machine (“VM”) of multiple VMs hosted at computer 1302. Furthermore, operating system 1330 can provide runtime environments, such as the Java runtime environment or the .NET framework, for applications 1332. Runtime environments are consistent execution environments that allow applications 1332 to run on any operating system that includes the runtime environment. Similarly, operating system 1330 can support containers, and applications 1332 can be in the form of containers, which are lightweight, standalone, executable packages of software that include, e.g., code, runtime, system tools, system libraries and settings for an application.

Further, computer 1302 can be enable with a security module, such as a trusted processing module (“TPM”). For instance with a TPM, boot components hash next in time boot components, and wait for a match of results to secured values, before loading a next boot component. This process can take place at any layer in the code execution stack of computer 1302, e.g., applied at the application execution level or at the operating system (“OS”) kernel level, thereby enabling security at any level of code execution.

A user can enter commands and information into the computer 1302 through one or more wired/wireless input devices, e.g., a keyboard 1338, a touch screen 1340, and a pointing device, such as a mouse 1342. Other input devices (not shown) can include a microphone, an infrared (“IR”) remote control, a radio frequency (“RF”) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1304 through an input device interface 1344 that can be coupled to the system bus 1308, but can be connected by other interfaces, such as a parallel port, an IEEE 1394 serial port, a game port, a USB port, an IR interface, a BLUETOOTH® interface, etc.

A monitor 1346 or other type of display device can be also connected to the system bus 1308 via an interface, such as a video adapter 1348. In addition to the monitor 1346, a computer typically includes other peripheral output devices (not shown), such as speakers, printers, etc.

The computer 1302 can operate in a networked environment using logical connections via wired and/or wireless communications to one or more remote computers, such as a remote computer(s) 1350. The remote computer(s) 1350 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1352 is illustrated. The logical connections depicted include wired/wireless connectivity to a local area network (“LAN”) 1354 and/or larger networks, e.g., a wide area network (“WAN”) 1356. Such LAN and WAN networking environments are commonplace in offices and companies, and facilitate enterprise-wide computer networks, such as intranets, all of which can connect to a global communications network, e.g., the Internet.

When used in a LAN networking environment, the computer 1302 can be connected to the local network 1354 through a wired and/or wireless communication network interface or adapter 1358. The adapter 1358 can facilitate wired or wireless communication to the LAN 1354, which can also include a wireless access point (“AP”) disposed thereon for communicating with the adapter 1358 in a wireless mode.

When used in a WAN networking environment, the computer 1302 can include a modem 1360 or can be connected to a communications server on the WAN 1356 via other means for establishing communications over the WAN 1356, such as by way of the Internet. The modem 1360, which can be internal or external and a wired or wireless device, can be connected to the system bus 1308 via the input device interface 1344. In a networked environment, program modules depicted relative to the computer 1302 or portions thereof, can be stored in the remote memory/storage device 1352. It will be appreciated that the network connections shown are example and other means of establishing a communications link between the computers can be used.

When used in either a LAN or WAN networking environment, the computer 1302 can access cloud storage systems or other network-based storage systems in addition to, or in place of, external storage devices 1316 as described above. Generally, a connection between the computer 1302 and a cloud storage system can be established over a LAN 1354 or WAN 1356 e.g., by the adapter 1358 or modem 1360, respectively. Upon connecting the computer 1302 to an associated cloud storage system, the external storage interface 1326 can, with the aid of the adapter 1358 and/or modem 1360, manage storage provided by the cloud storage system as it would other types of external storage. For instance, the external storage interface 1326 can be configured to provide access to cloud storage sources as if those sources were physically connected to the computer 1302.

The computer 1302 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (“Wi-Fi”) and BLUETOOTH® wireless technologies. Thus, the communication can be a predefined structure as with a conventional network or simply an ad hoc communication between at least two devices.

What has been described above include mere examples of systems, computer program products and computer-implemented methods. It is, of course, not possible to describe every conceivable combination of components, products and/or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
forming an antimicrobial coating by mixing a first solution comprising a tracer compound with a second solution comprising an antimicrobial compound; and
inhibiting growth of a microbe on a surface by applying the antimicrobial coating to the surface.

2. The method of claim 1, further comprising:
tracking application coverage of the antimicrobial coating on the surface by illuminating the surface with ultraviolet light and detecting light emitted by the tracer compound.

3. The method of claim 1, further comprising:
monitoring degradation of the antimicrobial coating on the surface by periodically determining whether the surface emits light in response to being radiated with ultraviolet light.

4. The method of claim 1, wherein the tracer compound is fluorescent, and wherein the antimicrobial compound is an organosilane compound.

5. The method of claim 4, wherein the antimicrobial compound is at least one member selected from the group consisting of β-lactams, aminoglycoside, macrolides, quinolones, and fluoroquinolones.

6. The method of claim 4, wherein the antimicrobial compound is at least one member selected from the group consisting of 3-(trihydroxysilyl) propyl dimethyl octadecyl ammonium chloride, 3-(trimethoxysilyl)propyl dimethyl octadecyl ammonium chloride, 1-tetradecanaminiumN,N-dimethyl-N-(3-(trimethoxysilyl)propyl)-chloride, and N,N-didecyl-N-methyl-3-(trihydroxysilyl)propyl dimethyl octoadecyl ammonium chloride.

7. The method of claim 1, wherein the antimicrobial coating is applied to the surface via an electrostatic sprayer.

8. A system comprising:
a memory that stores computer executable components;
a processor, operably coupled to the memory, and that executes the computer executable components stored in the memory, wherein the computer executable components comprise:
a tracking component that determines whether an antimicrobial coating is present on a surface by analyzing at least one of image data and sensor data regarding visible light emitted by the surface, wherein the antimicrobial coating includes a fluorescent tracer compound that emits the visible light in response to being radiated with ultraviolet light.

9. The system of claim 8, further comprising:
a light control component that activates a light source that illuminates the surface with the ultraviolet light.

10. The system of claim 9, further comprising:
a camera control component that commands a camera to capture the image data of the surface while the surface is illuminated by the ultraviolet light.

11. The system of claim 9, further comprising:
a sensor control component that activates an optical sensor positioned adjacent to the surface to capture the sensor data while the surface is illuminated by the ultraviolet light, wherein the sensor data characterizes at least one of an amount of the visible light emitted by the surface and an intensity of the visible light emitted by the surface.

12. The system of claim 8, further comprising:
an analysis component that identifies a first region of the surface coated with the antimicrobial coating based on a location of fluorescence emitted by the tracer compound and represented in the image data.

13. The system of claim 12, further comprising:
a notification component that generates a notification based on an area of the first region of the surface being less than a defined percentage of a total area of the surface.

14. The system of claim 13, further comprising:
a scheduling component that schedules an additional application of the antimicrobial coating to the surface based on the notification.

15. A computer-implemented method, comprising:
tracking, by a system operatively coupled to a processor, a presence of an antimicrobial coating on a surface based on an identification of fluorescence in image data representing an image of the surface.

16. The computer-implemented method of claim 15, further comprising:
illuminating, by the system, the surface with ultraviolet light; and
generating, by the system, the image data via a camera monitoring the surface during the illuminating.

17. The computer-implemented method of claim 16, further comprising:
analyzing, by the system, the image data to identify light having a defined wavelength corresponding to the fluorescence.

18. The computer-implemented method of claim 17, further comprising:
determining, by the system, a location of the antimicrobial coating on the surface based on the identified light.

19. The computer-implemented method of claim 18, further comprising:
generating, by the system, a notification based on the antimicrobial coating being an area of the location of the antimicrobial coating being less than a defined threshold.

20. The computer-implemented method of claim 19, further comprising:
scheduling, by the system, an additional application of the antimicrobial coating to the surface based on the notification.
